(19) United States
(12) Patent Application Publication
(10) Pub. No.: US 2003/0006128 A1
(43) Pub. Date: Jan. 9, 2003

(54) Two-shot molded backlit switch cap and method of manufacture

(76) Inventors: John T. Giles, Kenosha, WI (US); Wayne A. Pietluck, Pleasant Prairie, WI (US); Anthony J. Ceschin, Kenosha, WI (US); Brian K. Carpenter, Racine, WI (US)

Correspondence Address: JANSSON, SHUPE & MUNGER, LTD, 245 MAIN STREET, RACINE, WI, 53403, US

(21) Appl. No.: 09/897,344

(22) Filed: Jul. 3, 2001

(51) Int. Cl. H01H 9/00

(52) U.S. Cl. 200/314

(57) ABSTRACT

A backlit-compatible switch cap comprising a face portion formed by a first-shot mold of a synthetic resin and a skirt portion formed by a second-shot mold of synthetic resin and having a continuous top surface on which to apply a negative-image indicia through sublimation printing process and method for producing same.

### FIELD OF THE INVENTION

This invention relates generally to switch caps and in particular, to switch caps which are backlit-compatible.

### BACKGROUND

Indicia-marked switches are ubiquitous part of modem society. Caps are found in industrial, business, and residential use from control panels to calculators to alarm systems, and to computers. Use of keyboards, particularly computer keyboards, is not limited to situations of high-intensity ambient-light conditions.

One of the low-light applications is in emergency response vehicles, particularly police cruisers. Computers are an integral part of crime investigation. It is becoming commonplace for computers to be standard equipment in police cruisers. As these vehicles are in service 24 hours per day, it is important to have the keyboard functional in low-light conditions.

The best solution to keyboard illumination in low-light conditions is the backlit keyboard. By the term backlit keyboard, it is meant that illumination of the indicia on a cap is made by light traveling through the face of the cap from a light source behind the cap.

It is well recognized that the highest clarity of the backlit cap is obtained when the indicia is of a light-transmitting material surrounded by an opaque material. Thus, a backlit cap consists of at least three major components: a light source, a light-transmissible indicia, and an opaque background around the indicia.

The caps described by Moriike (U.S. Pat. No. 5,120,920) and Kline et al. (U.S. Pat. No. 5,993,019), involve a two-shot, indicia-molded cap. Most typically, the first shot in the molding process is of the light-transmissive resin which produces a transparent or translucent cap having a raised indicia on a face with an integrally molded skirt. Subsequent to the molding of the light-transmissive resin of the indicia-containing transparent cap, a second, opaque molding is formed around the exterior of the transparent portion of the cap surrounding the raised indicia. This arrangement involves two separate, major draw backs. First, each character is required to have its own mold for at least the transparent portion of the cap. A typical English-language-based keyboard contains between fifty and one hundred indicia-bearing caps. The Moriike/Kline inventions require a separate mold for each character, with concomitant capital costs for the production of dies. In turn, production requires changing of the dies as separate caps are molded. Moreover, there are related storage considerations for the dies and the finished caps. Further, by having separate molds for each character, should one break, the entire production of keyboards is shut down. Even further still, the process is not conducive to customizing indicia or to rapid production movement from one alphabet to another.

The second major drawback category for the Moriike/Kline approach is the transparent molding process creates a cap which requires a larger than necessary quantity of transparent synthetic resin to create a cap with an unnecessary skirt; moreover, the cap base and skirt are subsequently covered with the opaque synthetic resin. The result is that the caps are heavy and expensive to produce.

A second method of producing backlit caps is described in Takii et al. (U.S. Pat. No. 5,036,440). This process involves the creation of a generic cap of a transparent synthetic resin. The synthetic resin then is uniformly coated with an opaque ink. The opaque ink is then laser-etched away to produce the indicia in negative. While this approach reduces the materials cost as compared to the two-shot molding process of the prior references, the production costs remain high due to the necessity of the laser-machining engineering. Moreover, caps are produced individually by this process.

It would be an important improvement in the art to provide a generic, backlit cap with an opaque skirt and light-transmissive face, said face suited for receipt of printed ink, such that the face could be durably printed with an indicia easily capable of substitution.

### OBJECTS OF THE INVENTION

Therefore, it is an object of this invention to provide an improved cap to overcome some of the problems and shortcomings of the prior art.

It is a primary object and feature of the present invention to provide a two-shot molded cap switch cap of synthetic resin which has a skirt of one color and a face of a second color, suitable for application of an indicia.

It is a further object and feature of the present invention to provide an indicia-unspecific backlit cap capable of receiving a printed indicia specified after the molding process is complete.

It is a further object of this invention to provide a backlit cap which minimizes the light-transmissive synthetic resin necessary for manufacture.

It is a still further object and feature of the present invention to provide a backlit cap with a durable indicia.

It is yet another object of this invention to provide a molded cap which can remain intact despite accidental trauma.

It is a further object of the present invention to present a standard backlit cap such that the indicia may be easily customizable.

These and other objects of the invention will be apparent from the following descriptions and from the drawings.

### SUMMARY OF THE INVENTION

The invention involves a cap for use with a variety of switches such as toggle, push-button, slide and the like. A particularly useful application is for the switches of the keys of a computer key board. The switch cap of the present invention includes a face portion of a first color formed of a synthetic resin having a continuous upper surface, a perimeter, and edges; and a skirt portion of a second color formed of a synthetic resin, integral with the edges of the face portion and extending down from the face portion whereby the integrated face portion and skirt portion establish a dome with a substantially concave interior surface and a convex outer surface and wherein the upper surface of the face portion is a part of the outer surface of the dome. It is more preferred if the face portion is molded from a thermoplastic resin. It is more preferred that the skirt portion is molded of an opaque thermoplastic resin.

In another embodiment, the thermoplastic resin forming the face portion is light-transmitting. In this embodiment, it more preferable to provide a light source located relative to the concave interior surface whereby the light may pass through the face portion to the exterior of the cap. It is yet more preferred for the light source to be a light-emitting diode.

In another embodiment, the cap bears an indicia printed onto the upper surface of the face portion. It is more preferable if the indicia is printed in negative-image. It is yet more preferable if the printing is done through a sublimation process. The sublimation process is understood within the field to describe a process whereby sublimating ink in contact with the surface of a synthetic resin is heated under pressure to vaporize the ink and then cooled such that the ink becomes infused into the resin thereby dying the resin.

Another aspect of the invention is a method for forming a cap for a keyboard push button switch comprising the steps of (1) providing a synthetic resin face portion of a first color having a continuous upper surface, a perimeter, and edges; (2) molding a synthetic resin skirt portion of a second color integral with the edges of the face portion and extending back from the face portion; thereby forming a convex dome with a concave interior. This method is best accomplished when the face portion is a molded of a light-transmitting thermoplastic resin.

It is a preferred embodiment to print at least a portion of the face portion with an ink. It is more useful if the ink has light transmittance less than the face portion. It is still more useful if the placement of the ink on the surface of the face portion describes an indicia in negative.

In another embodiment of the method, the additional step of placing a light source relative to the concave interior such that the majority of the light passing through the concave interior from the light source which is visible outside the cap, passes through the indicia of the face portion. This step is more useful when the light source is a light-emitting diode.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is an isometric view of an array of caps forming a keyboard.

FIG. 2A is a top view of a first-shot cap face.

FIG. 2B is a cross-sectional view of a first-shot cap taken along line 2B-2B of FIG. 2A.

FIG. 2C is a cross-sectional view of a first-shot cap taken along line 2C-2C of FIG. 2A.

FIG. 3A is a top view of a second-shot cap face with opaque skirt.

FIG. 3B is a cross-sectional view of a second-shot cap face with opaque skirt taken along line 3B-3B of FIG. 3A.

FIG. 3C is a cross-sectional view of a second-shot cap face with opaque skirt taken along line 3C-3C of FIG. 3A.

FIG. 4 is a top view of a cap showing printed indicia.

FIG. 5 is a cross-sectional view of a cap in combination with a computer key switch containing a light-emitting diode.

FIG. 6 is a cross-sectional view of another type of cap in combination with another computer key switch containing a light-emitting diode.

FIG. 7 is an isometric view of an array of caps in place to form a keyboard in combination with a heat-transfer sheet containing dye suitable for a sublimation printing process.

FIG. 8 is a schematic representation of the sublimation process in operation.

### DETAILED DESCRIPTION OF THE DRAWINGS

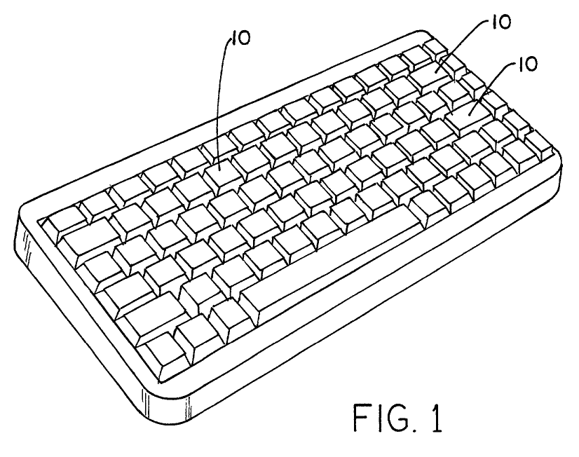

FIG. 1 shows an array of caps 10 in accordance with the invention, in a standard computer keyboard. It should be recognized that such use is for illustration only. The present invention is easily adaptable for other types of switches, including for example, other types of computer keyboard switches such as those in full-travel-membrane keyboards. Additional applications of the present invention include caps which are useful with switches in control panel and data-input devices and anywhere else indicia-bearing, backlit switch caps may be used.

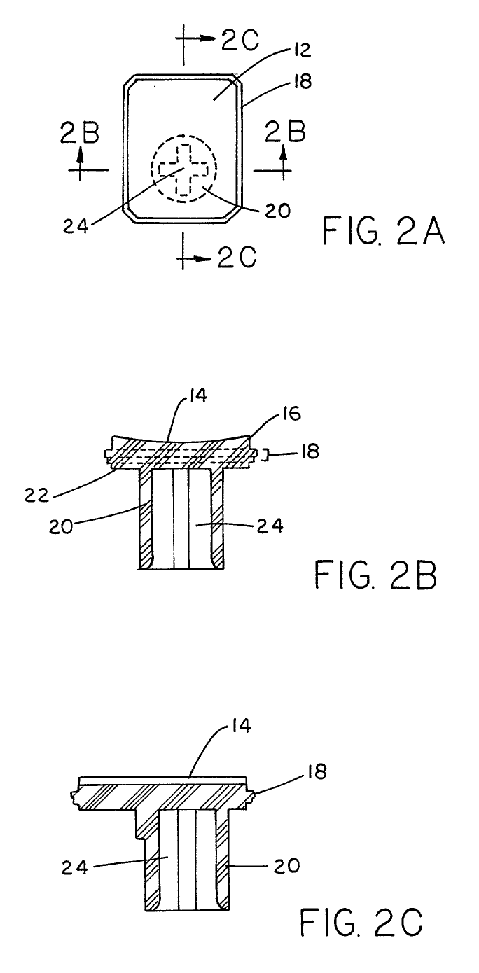

Turning to FIGS. 2A, 2B and 2C, the first-shot of the two-shot molding process is of the face portion 12. Face portion 12 includes a top surface 14 having a perimeter edge 16, a two-tiered locking element 18 extending laterally from perimeter edge 16. Face portion 12 further includes a mounting post 20 extending downwardly from the bottom surface 22 of face 12. Mounting post 20 is shown in phantom in FIG. 2A and is of a generally cylindrical shape having a longitudinal cavity 24 of a cross-shaped cross-section.

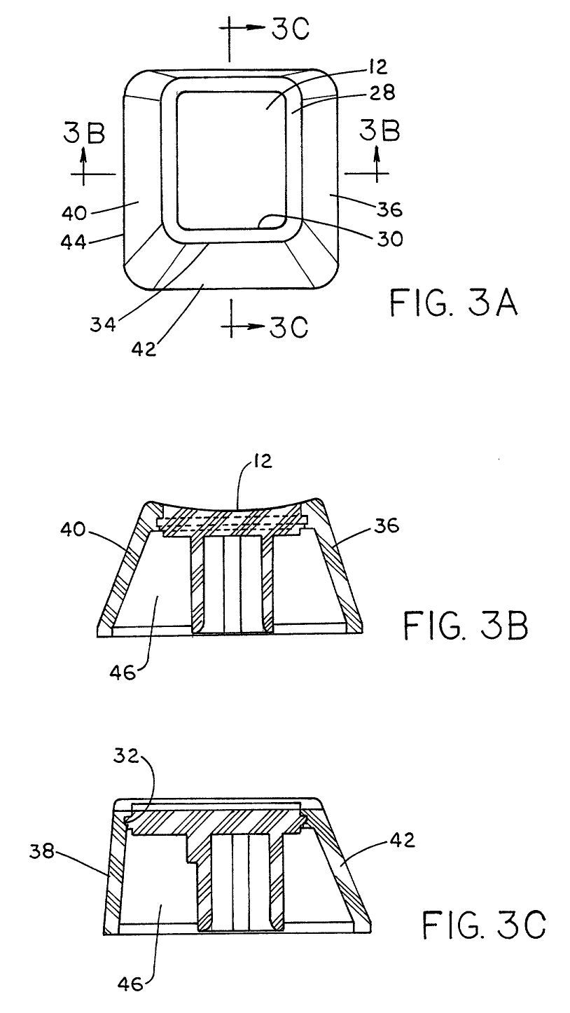

Turning now to FIGS. 3A, 3B and 3C, the second-shot of the two-shot molding process is of the skirt portion 26. Skirt portion 26 includes a top surface 28 having an inner perimeter edge 30, a two-tiered locking element 32 and an outer perimeter edge 34. Two-tiered locking element 32 is molded around and thus, complementary with, two-tiered locking element 18 of face portion 12. Skirt portion 26 further includes downwardly-extending side walls 36-42 which terminate in a lower edge 44. Lower edge 44 is of a greater circumference than outer perimeter edge 34. Side walls 36-42 define a substantially concave interior 46 therewithin.

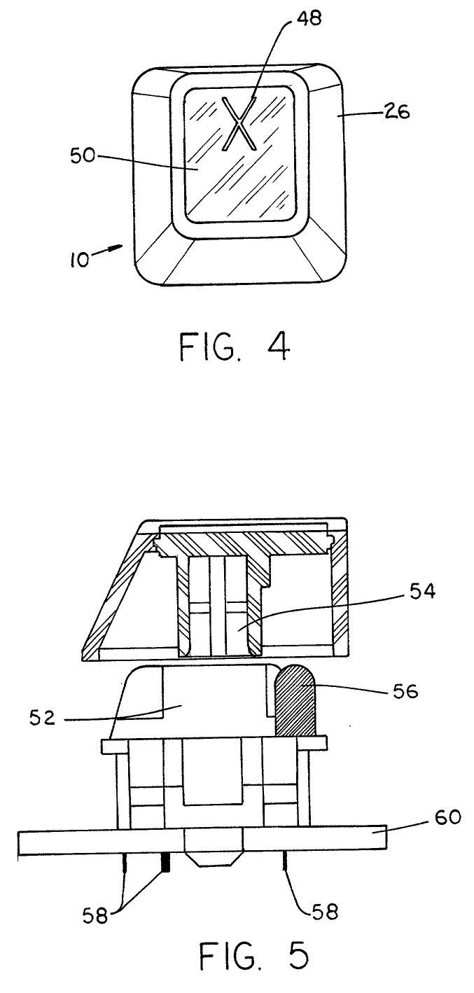

After the molding process is complete, indicia 48 is obtained by deposition of an ink 50 in a negative-image application to the top surface 14 of face portion 12 as shown in FIG. 4. By the term negative-image it is understood to mean the background surrounding the indicia is printed leaving the indicia portion in the void.

As shown in FIG. 5, cap 10 is attached to a switch 52. Switch 52 is a readily available switch such as those manufactured by Cherry Electric, Inc. Switch 52 includes a upwardly-extending peg 54 having a cross-shaped cross-section receivable within longitudinal cavity 24 of mounting post 20. Switch 52 further includes a light-emitting diode (LED) 56. Switch 52 also includes electrical connections 58 which engage circuit board 60 to provide power to LED 56 and to provide switch circuitry.

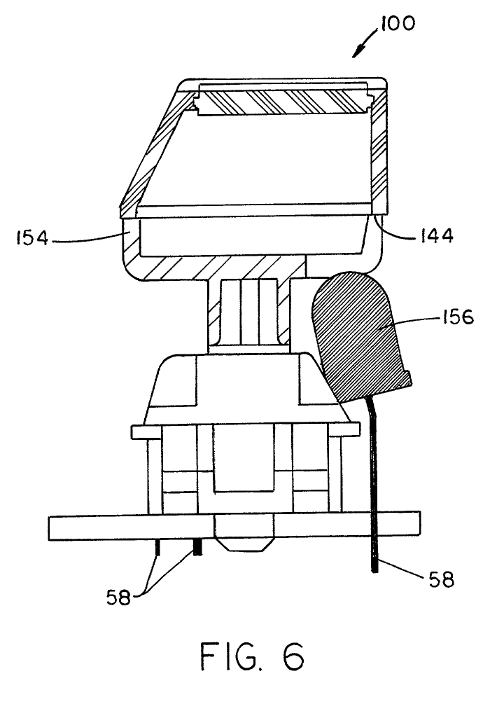

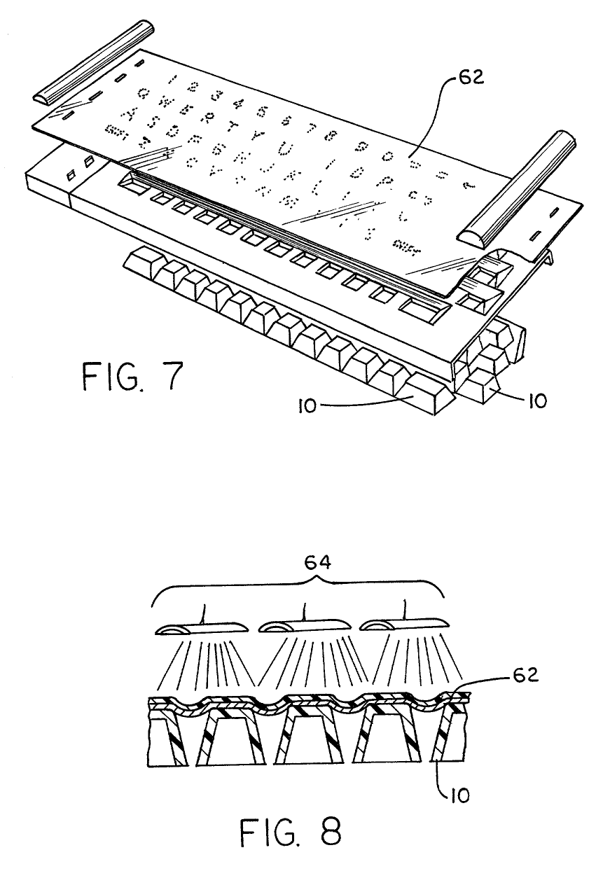

FIG. 6 depicts another embodiment of the switch cap referenced by number 100. The structure of cap 100 is the same as that of cap 10 except cap 100 does not include mounting post 20 within interior 46. Cap 100 engages switch 152 by snap-fit interface between cap 100 lower edge 144 and upper edge 154a of pan portion 154 of switch 152. Pan portion 154 includes an opening 154b to accommodate LED 156 when switch 152 is depressed.

Also disclosed is a method for making the two-shot, backlit cap 10. The first shot is of face portion 12 of cap 10 which is molded of a synthetic resin preferably a thermoplastic resin. Thermoplastic resins are preferred for their durability, moldability, chemical resistance, mechanical strength, frictional wear characteristics, fatigue properties, electrical characteristics and dimensional stability. Thermoplastic resins include, for example aromatic polyester resins, such as polybutylene terephthalates (PBT), and polyacetal resins. Of this group, PBT is the most highly preferred. Another popular synthetic resin for switch caps is synthetic rubber, such as silicone-based rubber such as that presently in wide use in the telephone industry. The instant technology is easily adapted to rubberized switch caps. Thermoplastic molding is well known in the industry and will not need to specified further here.

Face portion 12 is most preferably injection molded of a translucent PBT. While it is acceptable to mold face portion 12 of transparent PBT with a subsequent coating of a translucent paint, most typically white in color, it is preferable to mold face portion 12 of a translucent resin, for the following reasons: (1) the cost of the transparent and translucent resins are about the same; (2) the coating of a transparent face involves a second, unnecessary step thereby increasing production costs; and (3) a surface coating is subject to scratch off.

Face portion 12 is substantially planer but may have a slight concavity to top surface 14 as shown in FIGS. 2A-2C to provide a finger tip contour for ergonomic comfort. Regardless, face portion 12 presents a substantially flat continuous top surface 14 suitable for printing. Top surface 14 is a generic canvas onto which indicia 48 representing characters from any language may be placed.

Face portion 12 may or may not have an integrally-molded post 20. After the thermoplastic resin is cooled to a point of non-deformability, face portion 12 is subjected to a second-shot injection mold of an opaque thermoplastic resin to form skirt 26. Top surface 28 of skirt 26 presents a continuous surface with top surface 14 of face portion 12. It will be recognized that due to the cooling of the translucent face portion 12 to a point below the temperature of deformability, the bond that is made between the translucent thermoplastic resin and the opaque thermoplastic resin is mechanical. Nonetheless, due to the interlocking nature of locking elements 18 and 32, face portion 12 and skirt portion 26 of cap 10 will not come apart absent breaking or melting of cap 10. It should be recognized that the order of molding is obviously not important, i.e., skirt 26 may be molded before face portion 12. Likewise, it should be recognized that both face portion 12 and skirt 26 may be molded of opaque thermoplastic resins or both molded of transmissive thermoplastic resins, of differing or same colors to obtain aesthetically pleasing combinations irrespective of the backlit preferability.

Thereafter, caps 10 are arrayed on a form (not shown) in the desired positions that they will have in a completed customized keyboard. After cooling of the second-shot molding, top surface 14 is ready for printing. Most typically, the color of ink 50 is chosen to match skirt 26 color, but it may be of any color. Ink 50 chosen for a backlit key however, must be opaque.

The preferred printing process is a heat transfer/sublimation process utilizing dye-bearing sheets 62 in mirror-negative-image of the preselected images. Such processes are well known in the industry. One such process was described by Fukui in U.S. Pat. No. 4,820,310 which is incorporated herein by reference. Through the sublimation printing process, ink 50 is incorporated into the PBT resin such that top surface 14 of face portion 12 remains continuous.

In the present invention, dye-bearing sheets 62 are overlayed on the arrayed caps 10. Sheet 62 is maintained in a pressurized engagement with caps 10 while sheet 62 and caps 10 are heated by a heating apparatus 64. Heating apparatus 64 is well known in the industry, such as a Franklin Hot Stamping Machine Model 5100. The distance the heating apparatus 64 is maintained from caps 10, the time the heating apparatus 64 is in contact with caps 10, and the temperature at which the heating apparatus 64 provides heat to caps 10 is dependent on the specific application of resin and dye. Most typically the operating temperature is approximately 210° C. at 58 psi for approximately 60 seconds. It is preferred to utilize dense black impregnation dye.

It is well recognized that other printing methods such as screen printing method, dispenser method, potting method, pad printing method, and spray method may be used for specific purposes.

The two-shot molding process is particularly suited to the sublimation printing of caps 10. The sublimation process requires heating for a specified period of time at a specified distance from the ink transfer front/surface-to-be-printed. In the manner of the invention, the entire array of caps 10 for a keyboard may be printed from one transfer sheet 62 from one hot plate 64 coincidently, because skirt 26 is already opaque from the two-shot molding process and would not require printing. The present invention allows for the entire array to be printed at the same time and moreover is not dependent on the shape of any individual cap 10 within the array; a broader key such as an “enter” key of a standard QWERTY keyboard can be printed as a part of the array.

After printing, each cap 10, 100 is attached to a respective switch 52, 152 as shown in FIGS. 5 and 6. With respect to cap 10, cross-shaped longitudinal cavity 24 of mounting post 20 is dimensioned to receive cross-shaped cross-section peg 54 in mounting engagement. Cap 100 engages switch 152 by snap-fit interface between cap 100 lower edge 144 and upper edge 154a of pan portion 154 of switch 152.

As an alternative light source, an electroluminescent (EL) panel may replace LED light sources. Such design flexibility is particularly beneficial to full travel membrane keyboards or other boards where a general source of back lighting is provided rather than the individual keys receiving illumination from their own discrete source. LED lighting, however, is preferred to EL illumination by the present state of the art in typical use due to their lower cost, lower weight, lower wattage and amperage of operation, and longer life of operation.

While the principles of the invention have been shown and described in connection with but a few embodiments, it is to be understood clearly that such embodiments are by way of example and are not limiting.

I claim:

1. A cap for a switch comprising:
a face portion formed of a first synthetic resin having a continuous top surface, a perimeter, and edges; and
a skirt portion formed of a second synthetic resin integral with the edges of the face portion and extending downward from the face portion,
whereby, the integrated face portion and skirt portion define a substantially concave interior.

2. The cap of claim 1 wherein the face portion is molded from a thermoplastic resin.

3. The cap of claim 2 wherein the skirt portion is molded of an opaque thermoplastic resin.

4. The cap of claim 2 wherein the thermoplastic resin is light-transmitting.

5. The cap of claim 4 further comprising a light source located in proximity to the concave interior whereby the light may pass out through the face portion of the cap.

6. The cap of claim 5 wherein the light source is a light-emitting diode.

7. The cap of claim 2 wherein an indicia is printed onto the top surface of the face portion.

8. The cap of claim 7 wherein the indicia is printed in negative-image.

9. The cap of claim 7 wherein the printing is accomplished through a sublimation process.

10. A method for forming a cap for a switch comprising the steps:
molding a face portion of a first synthetic resin having a continuous top surface, a perimeter, and edges; and
molding a skirt portion of a second synthetic resin integral with the edges of the face portion and extending downward from the face portion,
thereby forming a substantially concave interior.

11. The method of forming a cap of claim 10 wherein the face portion is of a light-transmitting thermoplastic resin.

12. The method of forming a cap of claim 11 further comprising the step of printing at least a portion of the top surface of the face portion with an ink.

13. The method of forming a cap of claim 12 wherein the ink has light transmittance less than the light-transmitting thermoplastic resin of the face portion.

14. The method of forming a cap of claim 13 wherein the indicia is printed in negative-image.

15. The method of forming a cap of claim 14 comprising a further step of placing a light source in proximity to the concave interior whereby the light is transmitted out the indicia of the face portion.

16. The method of forming a cap of claim 15 wherein the light source is a light-emitting diode.
